(19) United States
(12) Patent Application Publication
(10) Pub. No.: US 2015/0077736 A1
(43) Pub. Date: Mar. 19, 2015

(54) SENSOR FOR COMBINED TEMPERATURE, PRESSURE, AND REFRACTIVE INDEX DETECTION

(71) Applicant: UNIVERSITY OF LIMERICK, Limerick (IE)

(72) Inventors: Thomas Reinsch, Potsdam (DE); Kort Bremer, Schneverdingen (DE); Elfed Lewis, County Clare (IE); Gabriel Leen, Cork (IE); Steffen Lochmann, Dahlewitz (DE)

(73) Assignee: UNIVERSITY OF LIMERICK, Limerick (IE)

(21) Appl. No.: 14/383,507

(22) PCT Filed: Mar. 19, 2013
(86) PCT No.: PCT/EP2013/055677

§ 371 Date: Sep. 5, 2014

(30) Foreign Application Priority Data
Mar. 22, 2012 (IE) 2012/0148

(51) Int. Cl. G01N 21/55; G01N 21/41; G01N 21/29; G01L 1/24; G01K 11/32

(52) U.S. Cl. CPC G01N 21/55; G01L 1/246; G01K 11/3206; G01N 21/29; G01N 21/4133; G01N 2201/088
USPC 356/32

(57) ABSTRACT

A sensor (1) has a light conductor (2) having a grating (FBG), a cavity (5), and a transparent cavity end wall (4), a light emitter for directing light through the conductor, and a light detector for detecting reflected light, and a processor. The processor is adapted to analyse light reflected due to the grating (FBG, 6) to determine an indication of temperature, light reflected from the end (7) of the cavity (5) to determine an indication of pressure, and also light reflected from the outer surface (8) of the cavity wall (4) to determine an indication of refractive index of a medium outside said cavity wall. The processor may use one output to compensate another, for example pressure and temperature may be used to compensate for variation in refractive index.

### FIELD OF THE INVENTION

The invention relates to sensors having optical fibres in which there is monitoring of reflected light to indicate a parameter.

### PRIOR ART DISCUSSION

Fibre optic sensors have been reported to measure only refractive index (RI) (e.g. [1-11]) or simultaneous RI and temperature (e.g. [12-17]).
[1] Y. Rao, “In-Line Fiber-Optic Fabry-Perot Refractive-Index Tip Sensors”, Proc. of SPIE Vol. 7133, 71332K, 2009.
[2] Z. Ran, Y. Rao, J. Zhang, Z. Liu and B. Xu, “A Miniature Fiber-Optic Refractive-Index Sensor Based on Laser-Machined Fabry-Perot Interferometer Tip”, JOURNAL OF LIGHTWAVE TECHNOLOGY, VOL. 27, pp. 5426-5429, 2009
[3] H. J. Patrick, A. D. Kersey and F. Bucholtz, “Analysis of the Response of Long Period Fiber Gratings to External Index of Refraction”, JOURNAL OF LIGHTWAVE TECHNOLOGY, VOL. 16, pp. 1606-1612, 1998.
[4] Y. Jung, S. Kim, D. Lee and K. Oh, “Compact three segmented multimode fibre modal interferometer for high sensitivity refractive-index measurement”, MEASUREMENT SCIENCE AND TECHNOLOGY, vol. 17, pp. 1129-1133, 2006.
[5] J.-H. Chen, J.-R. Zhao, X.-. Huang and Z.-J. Huang, “Extrinsic fiber-optic Fabry-Perot interferometer sensor for refractive index measurement of optical glass”, APPLIED OPTICS, Vol. 49, pp. 5592-5596, 2010.
[6] D. L. Goullon and K. Goswami, “Fiber optic refractive index sensor using a metal clad”, U.S. Pat. No. 4,929,049, 1990.
[7] J.-R. Zhao, X.-G. Huang, W.-X. He and J.-H. Chen, “High-Resolution and Temperature-Insensitive Fiber Optic Refractive Index Sensor Based on Fresnel Reflection Modulated by Fabry-Perot Interference”, JOURNAL OF LIGHTWAVE TECHNOLOGY, VOL. 28, pp. 2799-2803 2010.
[8] D. Monzon-Hemandez and J. Villatoro, “High-resolution refractive index sensing by means of a multiple-peak surface plasmon resonance optical fiber sensor”, Sensors and Actuators B, vol. 115, pp. 227-231, 2006.
[9] W. Liang, Y. Huang, Y. Xu, R. K. Lee and A. Yariv, “Highly sensitive fiber Bragg grating refractive index sensors”, APPLIED PHYSICS LETTERS, vol. 86, pp. 151122.1-151122.3, 2005.
[10] W. Chang Wong, C. C. Chan, L. H. Chen, Z. Q. Tou and K. C. Leong, “Highly sensitive miniature photonic crystal fiber refractive index sensor based on mode field excitation”, OPTICS LETTERS, vol. 36, pp. 1731-1733, 2011.
[11] R. Jha, J. Villatoro and G. Badenes, “Ultrastable in reflection photonic crystal fiber modal interferometer for accurate refractive index sensing”, APPLIED PHYSICS LETTERS, vol. 93, pp. 191106.1-191106.3, 2008.
[12] V. Bhatia, “Applications of long-period gratings to single and multi-parameter sensing”, OPTICS EXPRESS, Vol. 4, pp. 457-466, 1999.
[13] H. Y. Choi, G. Mudhana, K. S. Park, U. Paek and B. H. Lee, “Cross-talk free and ultra-compact fiber optic sensor for simultaneous measurement of temperature and refractive index”, OPTICS EXPRESS, vol. 18, pp. 141-149, 2009.
[14] C. R. Liao, Y. Wang, D. N. Wang and M. W. Yang, “Fiber In-Line Mach-Zehnder Interferometer Embedded in FBG for Simultaneous Refractive Index and Temperature Measurement”, IEEE PHOTONICS TECHNOLOGY LETTERS, VOL. 22, pp. 1686-1688, 2010.
[15] C. Zhao, X. Yang, M. Demokan and W. Jin, “Simultaneous Temperature and Refractive Index Measurements Using a 3° Slanted Multimode Fiber Bragg Grating”, JOURNAL OF LIGHTWAVE TECHNOLOGY, VOL. 24, pp. 879-883, 2006.
[16] D. W. Kim, F. Shen, X. Chen and Anbo Wang, “Simultaneous measurement of refractive index and temperature based on a reflection-mode long-period grating and an intrinsic Fabry-Perot interferometer sensor”, OPTICS LETTERS, Vol. 30, pp. 3000-3002, 2005.
[17] B. A. L. Gwandu, X. Shu, T. D. P. Allsop, W. Zhang, L. Zhang, D. J. Webb and I. Bennion, “Simultaneous refractive index and temperature measurement using a cascaded long-period grating device”, Proc. of IEEE Sensors 2002, pp. 1032-1035, 2002.
[18] A. D. Kersey et al, “Fiber Grating Sensors”, J. Lightw. Technol., vol. 15, pp. 1442-1463, 1997.
[19] D. Schulz (2001), “Beschreibung and Auswertungsmethodik von Multi-Fabry-Perot-Systemen”, unpublished thesis (PhD), Gerhard-Mercator-Universitat Duisburg
[20] J. Xu, X. Wang, K. L Cooper, G. R. Pickrell, and A. Wang, “Miniature fiber optic pressure and temperature sensors”, Fiber Optic Sensors Technology and Applications IV, Proc. of SPIE vol. 6004, 2005.
[21] Y. Zhu and A. Wang, “Miniature Fiber-Optic Pressure Sensor”, IEEE Photonics Technology Letters, vol. 17, pp. 447-449, 2005.
[22] K. K. Chin et al., “Interference of Fiber-Coupled Gaussian Beam Multiply Reflected Between Two Planar Interfaces”, IEEE Photonics Technology Letters, vol. 19, pp. 1643-1645, 2007.
[23] E. Cibula et al, “Miniature fiber optic pressure sensor for medical application”, IEEE Sensors, Orlando, Fla., USA 2002, pp. 711-714.
[24] D. Marcuse, “Loss analysis of single-mode fiber splices,” Bell Syst. Tech. J., vol. 56, pp. 703-718, May/June 1977.
[25] A. Majumdar and H. Huang, “Development of an in-fiber white-light interferometric distance sensor for absolute measurement of arbitrary small distances”, Applied Optics, vol. 47, pp. 2821-2828, 2008.

Prior art documents which describe approaches to use of optical fibres for sensors are:
1. Bremer K et al: “Fibre optic pressure and temperature sensor for geothermal wells”, Sensors, 2010 IEEE, IEEE, Piscataway, N.J., USA, 1 Nov. 2010 (2010-11-01), pages 538-541
2. DE4125036 C1 (Dornier GmbH)
3. WO2011/120147 A1 (Univ Victoria Innovat Dev [CA]; Wild Peter Martin [CA]; Dennison Chris)
4. CN202041465 U (Univ Harbin Eng)
5. Rao Y J et al: “In-line fiber Fabry-Perot refractive-index tip sensor based on endlessly photonic crystal fiber”, Sensors and Actuators A, Elsevier Sequoia S. A., Lausanne, C H, Vol. 148, No. 1, 4 Nov. 2008 (2008-11-04), pages 33-38

The invention is directed towards providing a sensor which is more versatile.

### SUMMARY OF THE INVENTION

According to the invention, there is provided a sensor comprising a light conductor having a grating, a cavity, a transparent cavity end wall, a light emitter for directing light through the conductor, a light detector for detecting reflected light, and a processor,
wherein the processor is adapted to:
   analyse light reflected due to the grating and process said data to determine an indication of temperature;
   analyse light reflected from the end of the cavity and process said data to determine an indication of pressure; and
   analyse light reflected from the outer surface of said cavity wall or a coating thereon, and process said data to determine an indication of refractive index of a medium outside said cavity wall.

In one embodiment, the processor is adapted to use at least one output to compensate another.

In one embodiment, pressure and temperature are used to compensate for variation in refractive index.

In one embodiment, the light conductor is an optical fibre. Preferably, the cavity is formed by a cylindrical glass structure at the end of the fibre. In one embodiment, the glass structure is a capillary.

In one embodiment, the cavity end wall is formed by a glass diaphragm or fibre section. In one embodiment, the processor is adapted to perform low-pass filtering to quantify light reflected back from the end of the cavity. In one embodiment, the processor is adapted to use said data to estimate cavity length, and to in turn use this to determine pressure.

In one embodiment, the processor is adapted to perform band-pass filtering to quantify light reflected back from the outside surface of the cavity wall. In one embodiment, the processor is adapted to use said data to estimate refractive index, and to in turn use said estimation to determine properties of the medium outside said cavity end wall.

In one embodiment, a coating is present on the outer surface of the cavity end wall and the refractive index of said coating changes in response to the presence of a fluid. In one embodiment, the coating has a reflectance or fluorescence property which changes with light wavelength, having a peak in a spectrum, and the processor is adapted to analyse said spectrum.

In one embodiment, the processor is adapted to use a normalised band pass fringe visibility function to compensate for variations in refractive index arising from light source variations.

In one embodiment, the processor is adapted to determine data concerning a fluid external to the cavity wall which includes water, and/or oil and/or a gas.

In one embodiment, the processor is adapted to derive information from light reflected back from the outside surface of the cavity wall.

In one embodiment, the light conductor is completely composed of fused silica.

In one embodiment, the processor is adapted to compensate for light losses within the light conductor due to beam divergence.

Preferably, the grating is a single mode fibre Bragg grating

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a diagrammatic cross-sectional view of a sensor of the invention, and FIG. 2 illustrates its manufacture;

FIG. 3 shows an experimental set-up interrogation system;

FIG. 4 shows simplified signal processing functions to provide outputs indicating temperature, pressure and refractive index of a fluid, this processing chain does not consider Gaussian beam divergence in the EFPI (Extrinsic Fabry-Perot Interferometer) cavity;

FIGS. 5 to 9 are plots illustrating sensed parameters;

FIG. 10 shows enhanced signal processing to provide outputs indicating temperature, pressure and refractive index of a fluid; and

FIG. 11 shows a simulation of the cross-sensitivity of the RI sensor to air cavity length changes.

### DESCRIPTION OF THE EMBODIMENTS

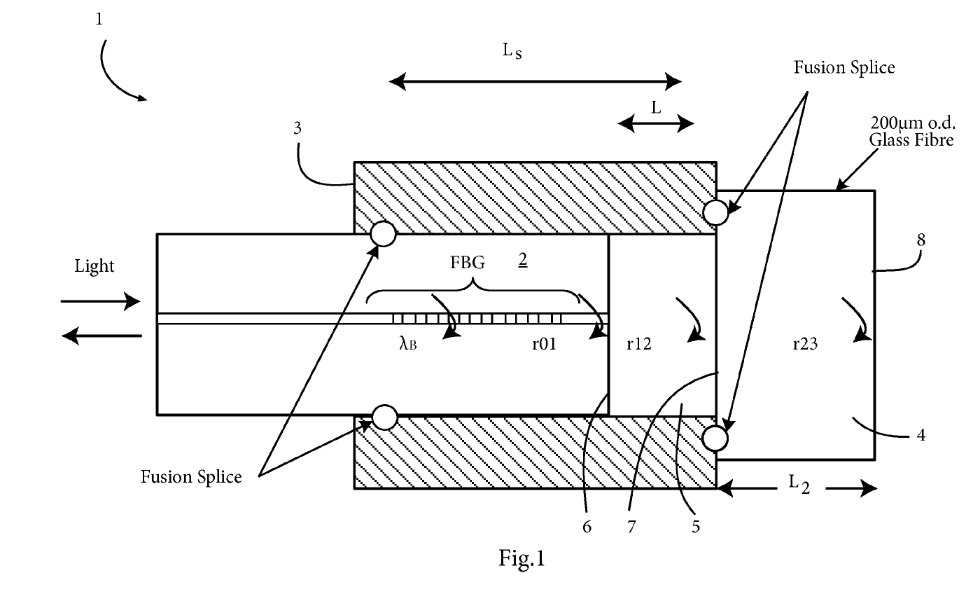

A schematic of a fibre optic pressure and temperature sensor 1 of the invention is illustrated in FIG. 1. The fibre optic sensor 1 was fabricated by using a Single Mode (SM) Fibre Bragg Grating (FBG) 2, a silica glass capillary 3 of length Ls and a 200 μm OD silica glass fibre 4 of length L2. There is an air cavity 5 of length L1 between the end of the FBG fibre 2 and the 200 μm OD fibre 4. There are therefore glass-air and air-glass interfaces at the edges of the cavity 5. The left hand cavity interface is given the numeral 6, the right hand cavity interface the numeral 7, and the end face of the 200 μm fibre 4 is given the numeral 8. There are therefore three main interfaces: an interface 6 with reflection r12, an interface 7 with reflection r12, and an interface 8 with reflection r23.

As shown in FIG. 2, initially (a) a glass capillary 50 was spliced to the 200 μm fibre 51 to provide a cavity end wall or diaphragm. Step (b) is the cleaving of the capillary 50 to the desired length. Following this, an SM fibre 52, which contains a FBG (Fibre Bragg Grating) was inserted ((c) and (d)) into the glass capillary 50 and both the silica glass components were also fused. Thereafter the 200 μm fibre was cleaved (e) several hundred microns from the glass capillary/200 μm fibre splice 55. This cleave may be closer than several hundred micron if suitable equipment is used. The next step (f), which is optional and dependent on the quality of the cleave and the desired length of the 200 μm fibre 51, involved polishing the 200 μm fibre 51, using polishing paper 60, to the desired length in order to make a diaphragm. In addition to polishing the 200 μm fibre 51 to the desired length, the 200 μm fibre 51 may also be etched using Hydrofluoric acid (HF), in order to reduce the thickness of the 200 μm fibre 51, in order to increase the sensitivity of the pressure sensing element. In an alternative embodiment, instead of using a 200 μm fibre, another SM (Single Mode) fibre could be inserted into the capillary 50.

The interface 8 may in use be with a medium including a gas, a liquid, or a solid. In the example of a solid it may be used in a precipitation process.

As shown in FIG. 1, incident light propagating to the sensor head is reflected at the FBG 2 for a wavelength equal to the Bragg wavelength λ_{B}, which is defined as [18]:

λ_{B}=2n_{eff}Λ (1)

where n_{eff} is the refractive index of the core material and Λ is the period of the grating. All other wavelengths propagate in normal matter through the fibre and are reflected at the glass/air interface of the SM fibre and at the air/glass as well as the glass/fluid interfaces of the 200 μm fibre. Both reflections transmit back into the SM fibre and generate light interference. The light interference can be described as [21]:

$$\frac{I ( λ , {L}_{1} )}{{I}_{0}} = {A}_{01}^{2} + {A}_{12}^{2} + {A}_{23}^{2} - 2 {A}_{01} {A}_{12} cos ( \frac{4 π {L}_{1}}{λ} ) + 2 {A}_{01} {A}_{23} cos ( \frac{4 π ( {L}_{1} + {n}_{2} {L}_{2} )}{λ} ) - 2 {A}_{12} {A}_{23} cos ( \frac{4 π {n}_{2} {L}_{2}}{λ} ) \qquad ( 2 )$$

where A₀₁, A₁₂ and A₂₃ are the amplitudes of the reflected light I_{R01}, I_{R12} and I_{R23}. n₂ is the refractive index of the silica glass fiber, L₁ is the length of the air cavity 5 between the FBG-SM fibre 2 end face 6 and inner surface 7 of the 200 μm glass fiber, L₂ is the length of the 200 μm fibre 4 and λ is the optical wavelength. In Equation 2 the first and second cosine term describe the interference between the FBG-SM fibre 2 endface 6 and the inner 7 as well as outer 8 200 μm glass fiber 4 surfaces. The third cosine term is the interference between the inner 7 and outer 8 surfaces of the 200 μm fibre 4. Furthermore, light losses within the air cavity 5 occur due to Gaussian beam divergence [22]. For a weakly guided step-index SM fibre, the fundamental HE₁₁ mode can be accurately approximated by a Gaussian distribution of a transverse and linearly polarised electric field [22]. As soon as the Gaussian beam propagates through the air cavity 5, its diameter increases and both the power density and the coupling coefficient decreases, which can be associated with losses within the cavity. The coupling coefficient η can be expressed as a function of longitudinal displacement as [23]:

$$\begin{matrix}η ( {L}_{1} ) = \frac{2 {w}_{0} w ( {L}_{1} )}{{w}_{0}^{2} + {w}^{2} ( {L}_{1} )} , \\ where & ( 3 ) \\ {w}^{2} ( {L}_{1} ) = {w}_{0}^{2} [ 1 + {( \frac{λ}{π {w}_{0}^{2}} 2 {L}_{1} )}^{2} ] . & ( 4 )\end{matrix}$$

Equation 4 describes the Gaussian beam radius after crossing the length L₁ of the EFPI air cavity 5. w₀ expresses the reference or mode field radius which can be calculated as [24]:

$$\frac{{w}_{0}}{b} = 0.65 + \frac{1.619}{{V}^{3 / 2}} + \frac{2.879}{{V}^{6}} . \qquad ( 5 )$$

In Equation 5, b is the fibre core radius and V represents the normalised frequency. Therefore the amplitudes A₀₁, A₁₂ and A₂₃ can be calculated as:

A₀₁=r₀₁, (6)

A₁₂=η·T·r₁₂, (7)

A₂₃=η·T²·r₂₃, (8)

where r₀₁ and r₁₂ are the reflectivity coefficients of the glass/air 6 and air/glass 7 interfaces of the first air cavity 5. η, and T are the coupling coefficient of the air cavity and the transmission of the glass/air interface 6. The coupling coefficient of the glass cavity (200 μm fibre) has been neglected. The reflectivity coefficient r₂₃ of the interface 8 between the refractive index of the 200 μm glass fibre n_{glass} and the surrounding medium n_{fluid} can be calculated as [19]:

$${r}_{23} = \frac{{n}_{glass} - {n}_{fluid}}{{n}_{glass} + {n}_{fluid}} . \qquad ( 9 )$$

Furthermore, when pressure is applied to the fibre optic sensor 1, the glass capillary 3 deforms and hence changes the EFPI cavity length L₁. The sensitivity of the sensor 1 (S_{P}) and hence the cavity length change ΔL_{P} due to applied pressure ΔP can be expressed as [20]:

$$Δ {L}_{P} = \frac{{L}_{s} {r}_{o}^{2}}{E ( {r}_{o}^{2} - {r}_{i}^{2} )} ( 1 - 2 μ ) Δ P = {S}_{P} Δ P \qquad ( 10 )$$

where μ is the Poisson's ratio of the glass capillary 3, E is the Young's modulus, L_{S} is the effective length of the pressure sensor, rᵢ and rₒ are the inner and outer radius of the glass capillary 3.

In addition, due to the thermal expansion of all glass components, the EFPI cavity 5 is also sensitive to temperature. The change of the EFPI cavity length ΔL_{T} as a result of temperature can be calculated as [20]:

$$Δ {L}_{T} = [ ( {α}_{C} - {α}_{F} ) {L}_{S} + {α}_{F} {L}_{1} + \frac{P}{T} {S}_{P} ] Δ T \qquad ( 11 )$$

In Equation 11 α_{C} and α_{F} are the Coefficients of Thermal Expansion (CTE) of the glass capillary 3 and the SM fibre 2.

The shift of the Bragg wavelength due to temperature can be expressed as [18]:

$$Δ {λ}_{B , T} = {λ}_{B} ( {α}_{S} + \frac{1}{{n}_{eff}} \frac{d {n}_{eff}}{d T} ) Δ T \qquad ( 12 )$$

where dn_{eff}/dT is the thermo-optic coefficient.

### Experimental Set-Up

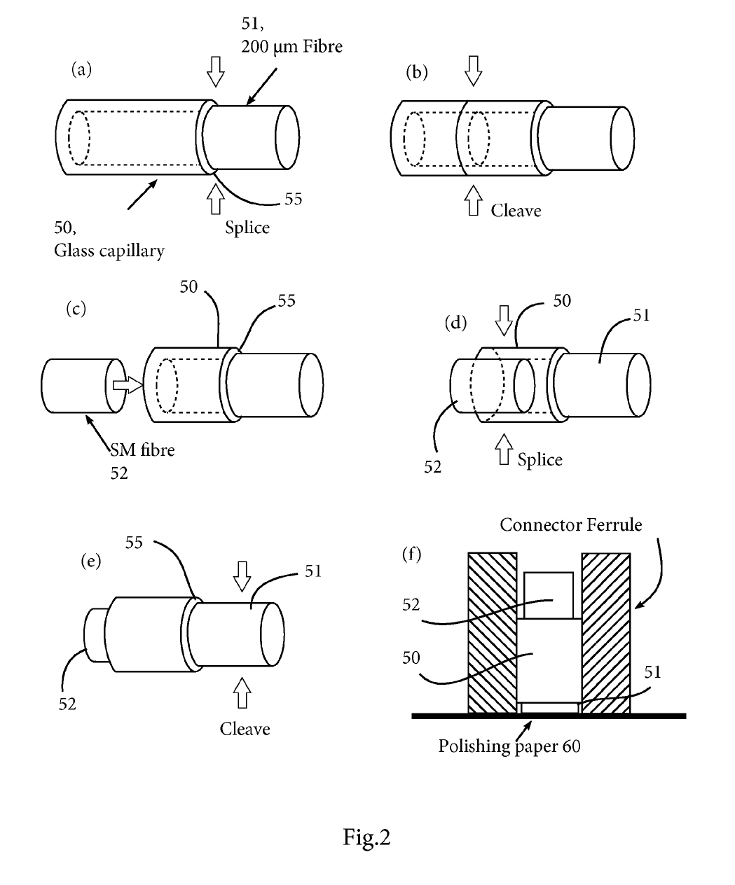

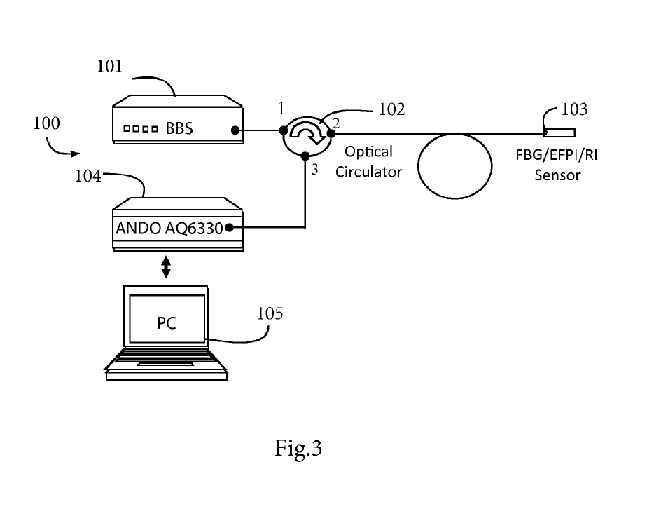

The fibre optic sensor was interrogated using an interrogation system 100 shown in FIG. 3. The interrogation system 100 consists of a Broad-Band Source (BBS) 101, an optical circulator 102 and an Optical Spectrum Analyser (OSA). Light from the BBS 101 is guided through the optical circulator 102 to the sensor and is reflected at the sensor head 103 back to the optical circulator 102 again. From the optical circulator 102 the reflected spectrum of the fibre optic sensor 103 is transferred to the OSA 104. The OSA 104 captures and normalises the reflected spectrum of the fibre optic sensor 103. A computer 105 is used to acquire and analyse the spectrum from the OSA 104.

In order to obtain the RI at the outer surface of the 200 μm fibre and the applied pressure and temperature, the signal processing 200 as displayed in FIG. 4 was applied.

The change of the temperature was determined directly from the obtained spectrum (201) by tracing (202) the Bragg wavelength. In contrast, the air cavity length change of the EFPI and the change of the RI at the outer surface of the 200 μm fibre were determined by filtering (203, 204) the obtained spectrum using a Low Pass (LP) and a Band Pass (BP) filter respectively. The cut-off frequency of the LP filter was set so that only the DC and the first cosine term in Equation 2 passed through the filter. In contrast, the cut-off frequencies of the BP filter were set so that only the third cosine term in Equation 2 passed through the filter.

The air cavity length 5 and hence the pressure and temperature information from the EFPI can be calculated (205) from the LP filtered spectrum using e.g. the following equation [25]:

$$L = \frac{Δϕ \cdot {λ}_{1} {λ}_{2}}{4 π ( {λ}_{2} - {λ}_{1} )} \qquad ( 13 )$$

where λ₁ and λ₂ are two wavelengths that are Δφ out of phase in the LP filtered spectrum.

The processing chain quantifies light reflected from the outer surface of the cavity wall 8 (the 200 μm OD fibre), or a coating on the cavity wall, and processes (206) said data to determine an indication of refractive index of a fluid or solid medium outside said cavity wall. The change of the RT at the outer surface of the 200 μm fibre is determined by analysing the amplitude of the BP filtered spectrum. One example would be the calculating the fringe visibility. The fringe visibility is defined as [19]:

$$γ = \frac{{I}_{max} - {I}_{min}}{{I}_{max} + {I}_{min}} \qquad ( 14 )$$

where Iₘₐₓ and Iₘᵢₙ are the maximum and minimum intensities of the optical interference, e.g. adjacent peak and valley points of the BP filtered spectrum.

### Experiments

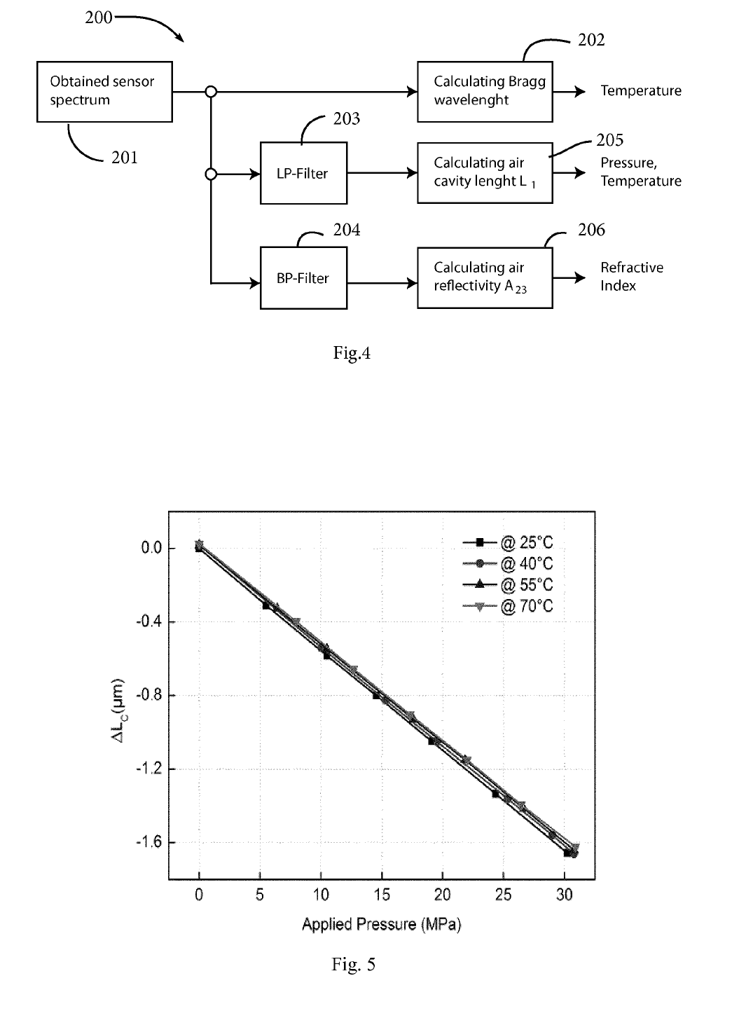

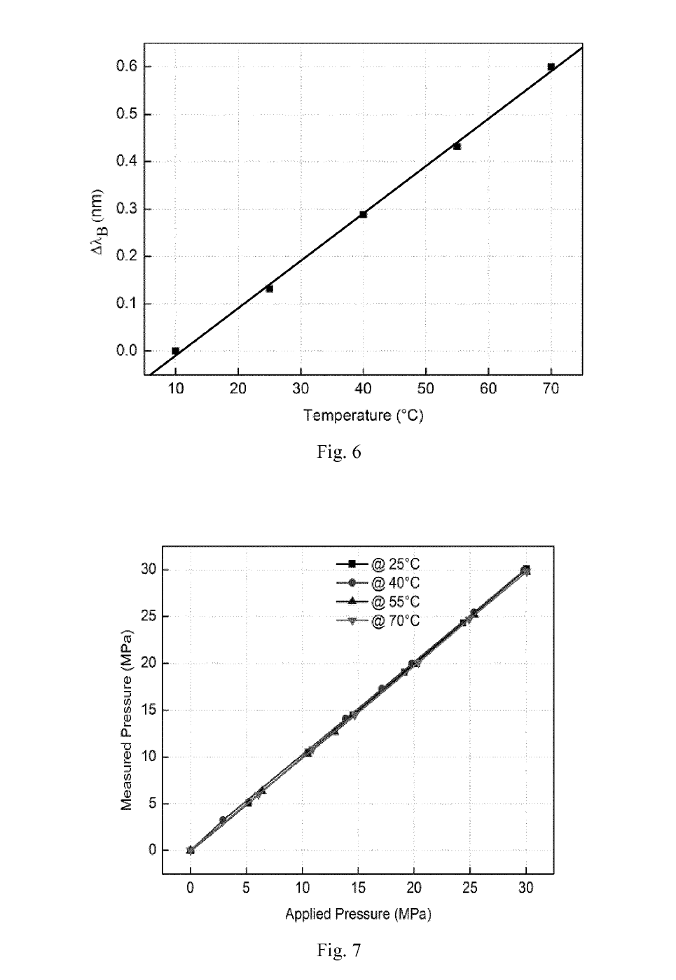

Initially, the ability of the sensor was verified for measuring pressure and temperature simultaneously. For this, the pressure and temperature response of the fibre optic sensor were evaluated by measuring pressure at different temperatures. Pressure experiments were started at ambient pressure (labelled with 0 MPa) and increased incrementally to 30 MPa for four different temperatures (25° C., 40° C., 55° C. and 70° C.). The temperature was kept constant during each pressure experiment. The change of the EFPI cavity 5 length due to applied pressure and temperature are shown in FIG. 5. As shown in FIG. 5, the EFPI cavity 5 shows a good linear correlation to applied pressure. Moreover, the temperature sensitivity is much smaller compared to the pressure sensitivity. Thus, for a relatively small temperature range, the cross-sensitivity of the EFPI cavity to temperature can be neglected. In FIG. 6, the temperature response of the FBG sensor is illustrated. The measured temperature response and sensitivity of the FBG sensor are consistent with those reported in literature, see e.g. [8]. Using the temperature information from the FBG the temperature cross-sensitivity of the EFPI can be compensated and the applied pressure can be calculated as depicted in FIG. 7.

Following this, the ability to measure RI at different temperatures of the fibre optic sensor was verified. In this analysis, five different sodium chloride solutions were prepared. In Table 1 the concentrations of the five different sodium chloride solutions are illustrated. They were measured using a FRI Refractive Index Sensor from FISO Technologies Inc.

TABLE 1
Concentrations of sodium chloride solutions

| mol/l | 0 | 1 | 2 | 3 | 4 |
|---|---|---|---|---|---|
| g/10 ml | 0 | 0.5835 | 1.668 | 1.7505 | 2.3338 |

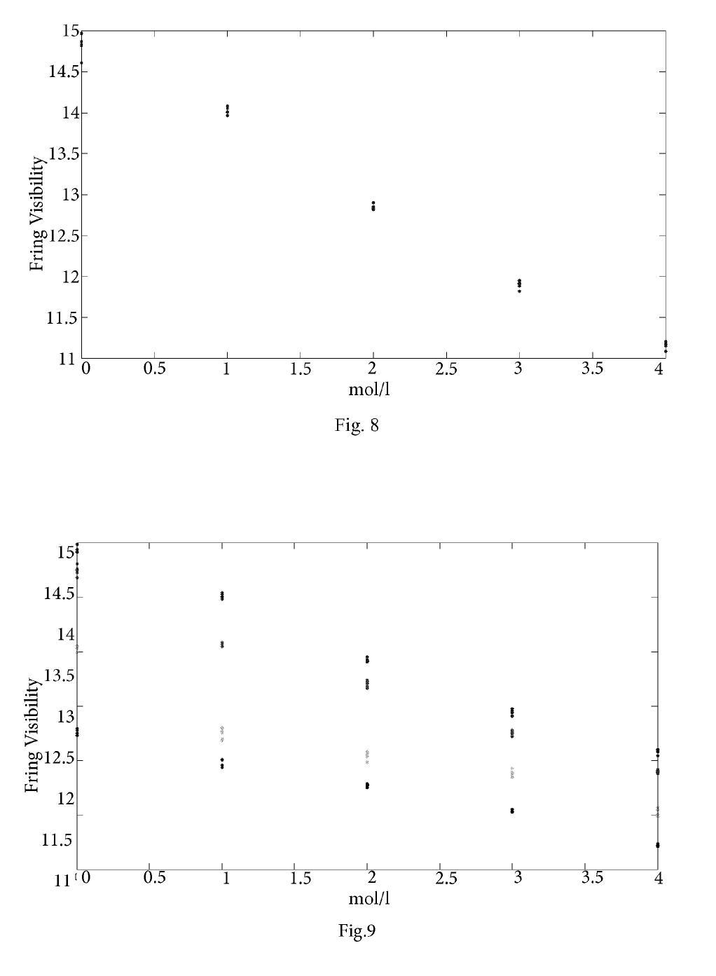

The change of the RI was measured by calculating the change of the amplitude of the third cosine term in Equation 2 using the fringe visibility. In FIG. 8 the result is displayed at 20° C.

As shown in FIG. 8, the fibre optic sensor was able to measure the change of the RI. Moreover, a good linear response was obtained between the measured fringe visibility and the measured RI. Following this, the RI response of the fibre optic sensor was evaluated at four different temperatures (20° C.—top dots, 40° C.—second from top dots, 60° C.—third from top dots and 80° C.—bottom dots) and the change of the fringe visibility is illustrated in FIG. 9.

As shown in FIG. 9, the fibre optic sensor was able to measure the RI at different temperatures. the RI of the sodium chloride solution changes at different temperatures, leading to a change in the fringe visibility. Using the temperature information and a signal processing method the temperature cross-sensitivity can be compensated.

The fibre optic sensor can also be applied to measure low pressure in one example. The pressure range depends only on the diaphragm thickness. However, in other uses a wide variety from very low to very high pressure sensitivities can be achieved due to changes of the diaphragm thickness.

Measuring refractive index at the tip of the fibre sensor is just one example of a measurement which can be inferred. The invention can also be applied to measure other parameters simultaneously with pressure and temperature; e.g. hydrogen detection or some other phenomena which changes the optical properties at the end face 8. For H detection, for example, a hydrogen-sensitive coating could be sputtered at fibre end face 8. When exposed to hydrogen, the coating changes its reflectance and hence the fringe visibility of the BP filtered spectrum (e.g. http://www.materion-gmbh.de/ provides such coatings).

The 200 μm glass fibre can be replaced by a SM fibre. In this case, instead of splicing the 200 μm fibre at the end face of the glass capillary, the SM fibre may be inserted into the glass capillary.

Depending on the pressure range and resolution, the dimension of the glass capillary can be changed. Apart from the diaphragm, the capillary deforms as well. Instead of splicing a diaphragm to the capillary, a piece of a SM fibre can be spliced into the capillary to create an air cavity. Applying pressure the capillary deforms (not the diaphragm/fibre) to give a signal.

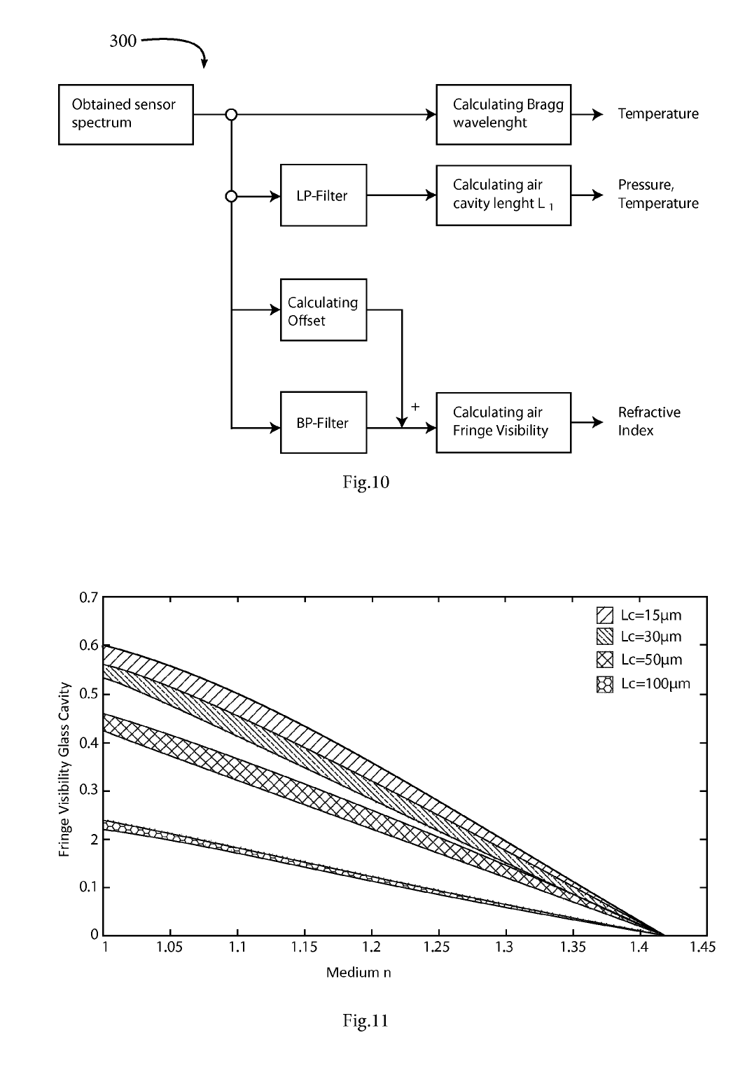

The signal processing method 200 shown in FIG. 4 may be used to determine temperature, pressure and an approximate value for refractive index. An enhanced signal processing method 300 is shown in FIG. 10, in which the DC part of the sensor spectrum is added to the BP filtered signal. Form this enhancement the fringe visibility in Equation 14 can be rewritten using Equation 2 as:

$$γ = \frac{2 {A}_{12} {A}_{23}}{{A}_{01}^{2} + {A}_{12}^{2} + {A}_{23}^{2}} . \qquad ( 15 )$$

From Equation 15 the cross-sensitivity of the fringe visibility of the RI sensor to air cavity 5 length changes ΔL₁ and hence pressure and temperature changes can be calculated. In FIG. 11 the cross-sensitivity of the fringe visibility of the glass cavity and hence of the RI sensor is simulated for four different air cavity length and an air cavity change of ΔL₁=6.2 μm. As shown in FIG. 11 the fringe visibility of the RI sensor is sensitive to length changes of the air cavity. However, the sensitivity is relatively small and for a large air cavity length the cross-sensitivity can be neglected.

For the sensor of the invention several other applications are feasible. Different fluids have different refractive indices and can be distinguished using a refractive index sensor. Therefore, the distinction between liquid and gas, for example, can be made based on refractive index measurements. As the refractive index of a fluid varies with temperature and pressure, the p/T/RI sensor allows for a direct compensation of these effects. Together with temperature and pressure, the refractive index allows for a complete description of a flowing two-phase fluid. Besides the distinction of the phase (liquid or gas) in contact with the sensor, changes in chemical composition of the fluid can be detected. For example, the salinity of water changes the refractive index. Therefore, the salinity of a fluid can be monitored using the p/T/RI sensor.

Using the capability of detecting the phase composition of a flowing multiphase fluid combined with the capability of detecting chemical changes within the fluid, the following applications are feasible:
Oil and gas sector: Detecting and quantifying multiphase flow within a well. Feed zones of gas, water, condensate or crude oil can be distinguished and quantified.
Geothermal sector: Detecting and quantifying two phase flow within a well. For high enthalpy wells, several parameters are important to know:
a. Feed zones for gas and liquid
b. Degassing of dissolved gases
c. Fluid composition (e.g. salinity)
Hydrogeology: Measuring and monitoring the salinity of water. For the supply of drinking water, it is important to monitor the salinity of water in order to detect a possible salinisation of drinking water reservoirs.
Laboratory applications: Several applications using the capability of measuring different phase compositions and changes in the chemical composition of a fluid are feasible.

The invention is not limited to the embodiments described but may be varied in construction and detail. For example, the cavity wall or diaphragm may have an external coating. The sensor may be adapted to determine data concerning a fluid external to the cavity wall which includes oil and/or gas. The system may be adapted for use in the geothermal sector, in the hydrogeology sector, or in laboratory settings. Also, the external interface may have a coating which has a reflectance or fluorescence property which changes with light wavelength, having a peak in a spectrum, and the processor is programmed to analyse across this spectrum to derive information about the external medium in contact with the coating.

1.-19. (canceled)

20. A sensor comprising a light conductor having a grating, a cavity, a transparent cavity end wall, a light emitter for directing light through the conductor, a light detector for detecting reflected light, and a processor,
wherein the processor is adapted to:
analyse light reflected due to the grating and process said data to determine an indication of temperature;
analyse light reflected from the end of the cavity and process said data to determine an indication of pressure; and
analyse light reflected from the outer surface of said cavity wall or a coating thereon, and process said data to determine an indication of refractive index of a medium outside said cavity wall.

21. The sensor as claimed in claim 20, wherein the processor is adapted to use at least one output to compensate another.

22. The sensor as claimed in claim 20, wherein the processor is adapted to use at least one output to compensate another; and wherein pressure and temperature are used to compensate for variation in refractive index.

23. The sensor as claimed in claim 20, wherein the light conductor is an optical fibre.

24. The sensor as claimed in claim 20, wherein the light conductor is an optical fibre, and wherein the cavity is formed by a cylindrical glass structure at the end of the fibre.

25. The sensor as claimed in claim 20, wherein the light conductor is an optical fibre, and wherein the cavity is formed by a cylindrical glass structure at the end of the fibre wherein the glass structure is a capillary.

26. The sensor as claimed in claim 20, wherein the cavity end wall is formed by a glass diaphragm or fibre section.

27. The sensor as claimed in claim 20, wherein the processor is adapted to perform low-pass filtering to quantify light reflected back from the end of the cavity.

28. The sensor as claimed in claim 20, wherein the processor is adapted to perform low-pass filtering to quantify light reflected back from the end of the cavity; and wherein the processor is adapted to use said data to estimate cavity length, and to in turn use this to determine pressure.

29. The sensor as claimed in claim 20, wherein the processor is adapted to perform band-pass filtering to quantify light reflected back from the outside surface of the cavity wall.

30. The sensor as claimed in claim 20, wherein the processor is adapted to use said data to estimate refractive index, and to in turn use said estimation to determine properties of the medium outside said cavity end wall.

31. The sensor as claimed in claim 20, wherein a coating is present on the outer surface of the cavity end wall and the refractive index of said coating changes in response to the presence of a fluid.

32. The sensor as claimed in claim 20, wherein a coating is present on the outer surface of the cavity end wall and the refractive index of said coating changes in response to the presence of a fluid; and wherein the coating has a reflectance or fluorescence property which changes with light wavelength, having a peak in a spectrum, and the processor is adapted to analyse said spectrum.

33. The sensor as claimed in claim 20, wherein the processor is adapted to use a normalised band pass fringe visibility function to compensate for variations in refractive index arising from light source variations.

34. The sensor as claimed in claim 20, wherein the processor is adapted to determine data concerning a fluid external to the cavity wall which includes water, and/or oil and/or a gas.

35. The sensor as claimed in claim 20, wherein the processor is adapted to derive information from light reflected back from the outside surface of the cavity wall.

36. The sensor as claimed in claim 20, where the light conductor is completely composed of fused silica.

37. The sensor as claimed in claim 20, wherein the processor is adapted to compensate for light losses within the light conductor due to beam divergence.

38. The sensor as claimed in claim 20, wherein the grating is a single mode fibre Bragg grating.
